(19) United States
(12) Patent Application Publication
(10) Pub. No.: US 2026/0358565 A1
(43) Pub. Date: Nov. 12, 2026

(54) WAFER-TO-WAFER BONDED COMPUTER SYSTEM WITH INTEGRATED OPTICAL CIRCUIT SWITCH-ENABLED REDUNDANCY

(71) Applicant: Lightmatter, Inc., Mountain View, CA (US)

(72) Inventors: Nikhil Kumar, East Palo Alto, CA (US); Srinivasan Ashwyn Srinivasan, Toronto (CA); Darius Bunandar, Boston, MA (US)

(73) Assignee: Lightmatter, Inc., Mountain View, CA (US)

(21) Appl. No.: 19/737,973

(22) Filed: Jul. 10, 2026

Related U.S. Application Data
(63) Continuation of application No. 19/668,742, filed on May 5, 2026.
(60) Provisional application No. 63/802,217, filed on May 8, 2025.

(51) Int. Cl. G02B 6/35; H04B 10/80

(52) U.S. Cl. CPC G02B 6/3598; H04B 10/801

(57) ABSTRACT

Described herein are multi-reticle computer systems based on wafer-to-wafer bonding. A system may include a photonic wafer patterned with a plurality of photonic tiles and a computer wafer patterned with a plurality of computer tiles. The computer wafer may be bonded to the photonic wafer such that each photonic tile is coupled to a corresponding computer tile. Each photonic tile may include a plurality of optical lanes configured to carry optical signals, a plurality of monitoring photodetectors configured to detect optical power levels in the optical lanes, and a plurality of switches coupled to the optical lanes. Each photonic tile may detect a defect on an optical lane based on a reduced optical power level detected by a monitoring photodetector and, in response, control the switches to divert light from the defective optical lane to a backup optical lane.

### CROSS-REFERENCE TO RELATED APPLICATIONS

This Application is a Continuation claiming the benefit under 35 U.S.C. 120 of U.S. application Ser. No. 19/668,742, filed May 5, 2026, entitled “WAFER-TO-WAFER BONDED COMPUTER SYSTEM WITH INTEGRATED OPTICAL CIRCUIT SWITCH-ENABLED REDUNDANCY”, which claims the benefit under 35 USC 119(e) of U.S. Provisional Application Ser. No. 63/802,217, filed May 8, 2025, each of which is hereby incorporated herein by reference in its entirety.

### BACKGROUND

Photonic integrated circuits (PICs) have emerged as a key technology for advancing the performance of modern computing and communication systems. By leveraging the high-speed and low-loss properties of light, PICs enable the transmission and processing of data at significantly higher bandwidths and lower latencies compared to conventional electronic interconnects. In addition, PICs support scalable architectures by facilitating parallel optical links that can be integrated alongside electronic circuitry. As a result, PICs are increasingly being adopted in data centers, artificial intelligence accelerators, high-performance computing, and other bandwidth-intensive applications.

The growing demand for high-bandwidth interconnects in data centers has accelerated the development and deployment of photonic technologies. Data centers process vast amounts of information and require efficient communication between servers, storage systems, and networking equipment. Optical interconnects offer advantages in terms of signal integrity over longer distances and reduced power consumption compared to electrical interconnects, making them attractive for data center architectures.

Some PICs are manufactured using complementary metal-oxide-semiconductor (CMOS) compatible processes. CMOS-compatible fabrication leverages existing semiconductor manufacturing infrastructure, which may decrease production costs and enable scaled production of photonic devices. The ability to utilize established foundry processes and equipment provides a pathway for high-volume manufacturing of PICs. Additionally, CMOS-compatibility may facilitate the integration of photonic and electronic components on a common platform, supporting the development of heterogeneous systems that combine optical and electrical functionality.

### SUMMARY

In some aspects, the techniques described herein relate to a system including: a photonic wafer patterned with a plurality of photonic tiles; a computer wafer patterned with a plurality of computer tiles, wherein the computer wafer is bonded to the photonic wafer such that each photonic tile of the plurality of photonic tiles is coupled to a corresponding computer tile of the plurality of computer tiles; wherein each photonic tile includes: a plurality of optical lanes configured to carry optical signals; a plurality of monitoring photodetectors configured to detect optical power levels in the plurality of optical lanes; and a plurality of switches coupled to the plurality of optical lanes; wherein each photonic tile is configured to: detect a defect on an optical lane of the plurality of optical lanes based on a reduced optical power level detected by a monitoring photodetector of the plurality of monitoring photodetectors; and in response to detecting the defect, control the plurality of switches to divert light from the defective optical lane to a backup optical lane.

In some aspects, the techniques described herein relate to a system, wherein each photonic tile further includes a photonic block including a plurality of transceivers configured to transmit data to and receive data from the corresponding computer tile.

In some aspects, the techniques described herein relate to a system, wherein each transceiver includes a transmitter including a modulator configured to encode data onto an optical carrier signal and to support four-level pulse amplitude modulation (PAM-4), the modulator including a Mach-Zehnder modulator, a ring modulator, or an electro-absorption modulator.

In some aspects, the techniques described herein relate to a system, wherein each photonic tile further includes a selector coupled to the plurality of switches, the selector configured to select one input from a plurality of available inputs provided by the plurality of switches and to route the selected input toward the photonic block.

In some aspects, the techniques described herein relate to a system, wherein the plurality of switches are configured to route light to the selector in response to detecting the defect and to route light to a neighboring photonic tile when no defect is detected.

In some aspects, the techniques described herein relate to a system, wherein, in response to detecting the defect, the plurality of switches are configured to divide optical power such that a first portion of the optical power is routed to the selector and a second portion of the optical power is routed to the neighboring photonic tile.

In some aspects, the techniques described herein relate to a system, wherein each photonic tile further includes a plurality of I/O switches, each I/O switch configured to interface with an external source or with an adjacent photonic tile.

In some aspects, the techniques described herein relate to a system, wherein the plurality of I/O switches are programmed based on whether the photonic tile is an edge tile positioned along a perimeter of the photonic wafer or a central tile positioned in an interior of the photonic wafer.

In some aspects, the techniques described herein relate to a system, wherein the defect includes a defective laser source or a defective edge coupler.

In some aspects, the techniques described herein relate to a system, wherein at least one photonic tile positioned in an interior of the photonic wafer is configured to exchange optical signals with an external optical source or sink via a grating coupler, such that data enters or exits the system without first traversing a perimeter photonic tile.

In some aspects, the techniques described herein relate to a system including: a first photonic wafer patterned with a plurality of photonic tiles; a first computer wafer patterned with a plurality of computer tiles, wherein the first computer wafer is bonded to the first photonic wafer such that each photonic tile of the plurality of photonic tiles is coupled to a corresponding computer tile of the plurality of computer tiles; wherein communication between nearest-neighbor computer tiles is conducted via electrical die-to-die interconnects; and wherein communication between non-nearest-neighbor computer tiles is conducted via the first photonic wafer.

In some aspects, the techniques described herein relate to a system, further including a second photonic wafer bonded to a second computer wafer, wherein the first photonic wafer is optically coupled to the second photonic wafer such that a computer tile on the first computer wafer communicates optically with a computer tile on the second computer wafer without electrical tile-to-tile hops.

In some aspects, the techniques described herein relate to a system, wherein each photonic tile includes a plurality of optical lanes and a plurality of switches coupled to the plurality of optical lanes, the plurality of switches configured to route optical signals between photonic tiles.

In some aspects, the techniques described herein relate to a system, wherein the first photonic wafer and the first computer wafer are bonded through wafer-on-wafer hybrid bonding.

In some aspects, the techniques described herein relate to a system, wherein the first photonic wafer is optically coupled to an external optical switch such that a computer tile on the computer wafer communicates optically with the external optical switch without electrical tile-to-tile hops.

In some aspects, the techniques described herein relate to a photonic wafer including: a plurality of photonic tiles arranged in a grid pattern, each photonic tile including: a plurality of optical lanes configured to carry optical signals; a plurality of monitoring photodetectors configured to detect optical power levels in the plurality of optical lanes; and a plurality of switches coupled to the plurality of optical lanes; wherein each photonic tile is configured to: detect a defect on an optical lane of the plurality of optical lanes based on a reduced optical power level detected by a monitoring photodetector of the plurality of monitoring photodetectors; and in response to detecting the defect, control the plurality of switches to divert light from the defective optical lane to a backup optical lane; wherein the photonic wafer is configured for wafer-to-wafer bonding with a computer wafer such that each photonic tile is aligned with a corresponding computer tile of the computer wafer.

In some aspects, the techniques described herein relate to a photonic wafer, wherein each photonic tile further includes a photonic block including a plurality of transceivers configured to interface with a corresponding computer tile when the photonic wafer is bonded to the computer wafer.

In some aspects, the techniques described herein relate to a photonic wafer, wherein the photonic wafer and the computer wafer are bonded through wafer-on-wafer hybrid bonding.

In some aspects, the techniques described herein relate to a photonic wafer, wherein the defect includes a defective laser source or a defective edge coupler.

In some aspects, the techniques described herein relate to a photonic wafer, wherein at least one photonic tile positioned in an interior of the photonic wafer is configured to exchange optical signals with an external optical source or sink via a grating coupler, such that data enters or exits the photonic wafer without first traversing a perimeter photonic tile.

### BRIEF DESCRIPTION OF FIGURES

Non-limiting and non-exhaustive examples are described with reference to the following figures.

FIG. 1 illustrates an exploded view of a wafer-to-wafer bonding configuration, according to aspects of the present disclosure.

FIG. 2A illustrates a top-down view of a photonic wafer comprising an array of photonic tiles, according to aspects of the present disclosure.

FIG. 2B illustrates a schematic view of a photonic tile subset coupled to a laser bank via a fiber coupler, according to aspects of the present disclosure.

FIG. 3 illustrates a system diagram of a photonic tile architecture showing an arrangement of I/O switch banks and photonic blocks, according to aspects of the present disclosure.

FIG. 4 illustrates a detailed block diagram of a photonic tile configuration showing routing and switching architecture for laser input and data output, according to aspects of the present disclosure.

FIG. 5 illustrates a detailed view of switching and routing architecture within a photonic tile, according to aspects of the present disclosure.

### DETAILED DESCRIPTION

Wafer-scale compute architectures may involve an entire wafer of computer tiles that are electronically stitched together to form a large-scale processing system. In some aspects of the present disclosure, a photonic wafer may be hybrid bonded to a computer wafer, creating an integrated system where the photonic wafer provides optical communication capabilities to the computer wafer. The computer wafer may include multiple computer tiles arranged in a grid pattern, and the photonic wafer may include corresponding photonic tiles arranged in a matching grid pattern. When bonded together, the computer tiles may align with the photonic tiles to enable communication between the compute and photonic layers.

Conventional electrical die-to-die interconnects in wafer-scale compute architectures may be limited to nearest-neighbor communication. Electrical signals traveling across long metal traces may experience significant parasitic capacitance and resistance, which may degrade signal integrity and limit achievable data rates. These parasitics may increase with trace length, making it impractical to route electrical signals across multiple reticles without substantial signal degradation. In such configurations, data from a previous calculation may need to be placed such that the next calculation happens on an adjacent die or reticle. This constraint may create significant compilation challenges, as arranging reticle-to-reticle communication and compute placement becomes complex when limited to electrical nearest-neighbor communication. The compilation process may need to send not only instructions but also data, and the placement of computations may be constrained by the physical proximity requirements of electrical interconnects.

To overcome this limitation, conventional systems may be designed to start a computation from an edge tile of the wafer and then proceed on a neighbor-to-neighbor basis across the array of tiles. Data may be passed sequentially from one tile to an adjacent tile, with each computational step occurring on a neighboring tile before results can be forwarded to the next neighbor. This approach may require careful orchestration of data movement and computation scheduling to ensure that intermediate results are available at the correct neighboring tile when needed. However, this neighbor-to-neighbor constraint may limit the full capability of the multi-tile computer by restricting the flexibility of computation placement and data routing. The requirement to traverse multiple intermediate tiles to reach a distant destination may introduce latency and reduce overall system throughput. Additionally, the edge-to-edge communication pattern may leave central tiles underutilized or create bottlenecks when multiple data streams must traverse overlapping paths through the tile array.

Aspects of the present disclosure relate to multi-reticle computer systems based on wafer-to-wafer bonding. In such systems, a computer wafer containing electronic processing circuitry may be bonded to a photonic wafer containing optical communication circuitry. The computer wafer may include multiple reticles, where each reticle corresponds to a single lithographic exposure during fabrication. A tile may be an instantiation of a reticle shot, such that the terms tile and reticle may be used interchangeably to refer to the same physical region of the wafer. Each tile on the computer wafer may contain one or more computer elements that perform computational operations. The photonic wafer may similarly include multiple reticles (tiles), each containing one or more photonic elements that provide optical input/output and routing capabilities. Unlike conventional bonded systems where individual dies are diced from wafers and then bonded, the present approach may perform bonding at the wafer level without dicing. The entire computer wafer may be bonded to the entire photonic wafer, such as a 12-inch wafer bonded to a 12-inch wafer, an 8-inch wafer bonded to an 8-inch wafer, or a 6-inch wafer bonded to a 6-inch wafer.

The computer wafer and the photonic wafer may be bonded through wafer-on-wafer hybrid bonding. Hybrid bonding may create both mechanical attachment and electrical connections between the two wafers simultaneously. In some embodiments, the photonic tile size may match the computer tile size, such that each photonic tile aligns with a corresponding computer tile of the same dimensions. The tile size may extend up to a single reticle, corresponding to the maximum area that can be patterned in a single lithographic exposure. To create tiles or interconnected regions that extend beyond a single reticle, electrical stitching and optical waveguide stitching may be employed. Electrical stitching may connect metal traces across reticle boundaries, while optical waveguide stitching may align waveguide segments across reticle boundaries to enable continuous optical signal propagation. During the bonding process, the computer wafer and the photonic wafer may be aligned such that the computer tiles on the computer wafer are positioned directly above or below corresponding photonic tiles on the photonic wafer. This wafer-to-wafer bonding approach may enable high-density interconnections between the compute and photonic layers, allowing optical signals to be efficiently coupled to and from the electronic processing elements.

Photonics may enable communication that is not limited to nearest-neighbor or die-to-die constraints. Optical communication may allow data to jump multiple reticles within a single wafer or travel to a different computer wafer entirely. Optical signals propagating through waveguides may be substantially immune to the parasitic capacitance and resistance effects that limit electrical interconnects. Unlike electrical signals that must charge and discharge parasitic capacitances along metal traces, optical signals travel as electromagnetic waves confined within waveguide structures and do not interact with the surrounding dielectric or conductive materials in the same manner. This immunity to electrical parasitics may allow optical signals to maintain signal integrity over distances spanning multiple reticles without the degradation experienced by electrical signals. This capability may simplify compilation, provide higher bandwidth, and enable access to the middle of the computer wafer rather than requiring communication to start from the edges. By leveraging optical interconnects, a wafer-scale compute system may overcome the limitations of purely electrical communication.

The inventors have recognized and appreciated that different communication distances within a wafer-scale compute system have different optimal interconnect solutions. For nearest-neighbor communication, electrical die-to-die interconnects are well-suited due to their simplicity and low latency for short distances. However, when communication must span multiple tiles, optical interconnects become advantageous because they avoid the cumulative parasitic effects of traversing intermediate tiles electrically. Accordingly, a wafer-to-wafer bonded system may employ a hybrid electrical/optical interconnect strategy based on the number of die hops required for communication. Communication between nearest-neighbor computer tiles may be conducted via electrical die-to-die interconnects, while communication between non-nearest-neighbor computer tiles may be conducted via the photonic wafer. For example, when the number of die hops N is equal to 1, the communication path may utilize electrical die-to-die interconnects that traverse directly between adjacent tiles. When the number of die hops N is greater than or equal to 2, the communication path may utilize optical interconnects provided by the photonic wafer, allowing data to bypass intermediate tiles entirely. This hybrid approach represents an efficient allocation of interconnect resources, using each technology where it excels; electrical interconnects for short-distance communication and optical interconnects for longer-distance communication across the wafer.

While photonics may provide these communication advantages in wafer-scale compute systems, such systems may still face challenges related to manufacturing defects. Defects may occur during fabrication, affecting components such as lasers, edge couplers, or waveguides. Conventional solutions to maintain yield despite the presence of defects rely on optical circuit switching (OCS). However, conventional OCS solutions involve bulky external devices that may not be suitable for integrated wafer-scale architectures. Such external OCS devices may require separate packaging, additional fiber connections, and discrete optical components that introduce latency, insertion loss, and alignment challenges when interfacing with densely integrated photonic wafers. The physical footprint and power requirements of standalone OCS boxes may be incompatible with the compact, high-density integration goals of wafer-to-wafer bonded systems.

Recognizing these limitations, the inventors have developed multi-reticle OCS-enabled photonic wafers that provide redundancy and reconfiguration capabilities on a single integrated platform. Rather than relying on external optical circuit switching devices that introduce additional packaging complexity, fiber connections, and alignment challenges, the present disclosure integrates the OCS functionality directly within the photonic wafer. The transceiver architecture may enable dynamically reconfigurable network topologies without requiring bulky external boxes, thereby maintaining the compact, high-density integration goals of wafer-to-wafer bonded systems. A redundancy and resiliency enabling switching network may be provided on both the laser input side and the data output side of each tile. On the laser input side, the switching network may enable rerouting of optical power from functioning laser sources to compensate for failed or defective laser sources or edge couplers. On the data output side, the switching network may enable rerouting of modulated optical signals to alternative output paths when primary output paths are unavailable or when different network topologies are desired. For example, output-side switches may direct signals to a different tile on the same wafer or to a different wafer entirely, effectively functioning as a router that provides flexibility in determining which compute elements communicate with each other. The switching network may span across multiple photonic tiles, enabling multi-reticle optical circuit switching that provides system-level redundancy and reconfiguration capabilities across the entire photonic wafer.

The switching architecture may enable optical routes that skip multiple compute elements, representing a key differentiator from nearest-neighbor electrical communication. Unlike electrical interconnects that must traverse each intermediate tile sequentially, the optical switching network may allow data to bypass intermediate tiles entirely, jumping directly to a distant tile within the same wafer or exiting to a different wafer altogether. This capability transforms the photonic layer from a simple communication medium into a flexible routing fabric that can dynamically configure which compute elements communicate with each other, regardless of their physical proximity on the wafer.

Failure detection may be accomplished using monitor photodiodes. When a failure is detected, such as a loss of light in a particular lane, telemetry signals may trigger reconfiguration of switches to reroute optical signals. In some embodiments, if light is lost in a lane, switches may be reconfigured to divert light from the defective lane to a backup lane, such as a lane served by a different bank or an adjacent edge coupler. The backup lane may be selected from a plurality of available backup lanes based on proximity to the defective optical lane. Selection based on proximity may minimize optical path length, reduce insertion loss, and simplify the switch reconfiguration required to establish the backup path. This switching mechanism may provide redundancy without requiring complete duplication of all optical components. Rather than dedicating a full backup laser source for each lane, the system may enable controllable, partial redundancy where light from one laser source can be shared or split to compensate for a failed source while still serving its original destination. For example, if one laser fails, an adjacent laser may provide a portion of its optical power to the affected lane while continuing to serve its primary lane at a reduced but still functional power level. This approach may provide redundancy with significantly reduced overhead compared to full duplication of laser sources, as not every lane requires a dedicated backup laser.

Similarly, if an edge coupler fails or exhibits excessive insertion loss, the switching network may redirect optical signals through an alternative edge coupler that remains functional. The monitor photodiodes may detect reduced optical power levels indicative of edge coupler degradation, and the control system may respond by reconfiguring the switches to route signals through a neighboring edge coupler path. This edge coupler redundancy may be particularly valuable because edge couplers interface between external fiber connections and on-chip waveguides, representing a critical point of potential failure in the optical signal chain.

The switching architecture may be compatible with unidirectional or bidirectional configurations, as well as interleaved or multiplexed arrangements. In some embodiments, a generalized Mach-Zehnder interferometer (GMZI) may be used to limit the number of switches required while still providing the desired routing flexibility. A GMZI may extend the two-input, two-output switching capability of a conventional MZI to an N×N configuration by arranging multiple input and output waveguides with a single stage of phase shifters positioned between two multi-mode interference (MMI) couplers or star couplers. Unlike cascaded arrangements of 2×2 MZI switches that require multiple switching stages to achieve full connectivity, the GMZI may provide arbitrary permutation of N input ports to N output ports using only one depth of phase shifter. This single-stage architecture may reduce the total number of phase shifters required, decrease cumulative insertion loss, and simplify control complexity compared to multi-stage switch fabrics. The GMZI may enable port reordering with reduced optical path length through the switching network, thereby reducing the complexity and optical loss of the switching network.

In some embodiments, the system may include multiple wafer-to-wafer bonded assemblies that communicate optically with each other. A second photonic wafer may be bonded to a second computer wafer, forming a second wafer-scale compute assembly. The first photonic wafer may be optically coupled to the second photonic wafer such that a computer tile on the first computer wafer communicates optically with a computer tile on the second computer wafer without requiring electrical die-to-die hops between the wafers. This inter-wafer optical communication may enable scaling of the compute system beyond the capacity of a single wafer while maintaining the bandwidth and latency advantages of optical interconnects.

In some embodiments, the photonic wafer may be optically coupled to an external optical switch, such that a computer tile on the computer wafer communicates optically with the switch without electrical die-to-die hops. The optical switch may provide reconfigurable connectivity between multiple wafer-scale compute assemblies or between the wafer-scale compute assembly and other optical network elements. This switch connectivity may enable dynamic allocation of communication bandwidth between different compute resources based on workload requirements.

In some embodiments, an additional photonic wafer may be bonded below the existing wafer stack, providing additional active photonic layers. The first photonic wafer, which is bonded to the computer wafer, may be optically coupled to the second photonic wafer positioned below. This multi-layer photonic architecture may increase the available optical routing capacity and enable more complex optical network topologies within the wafer-scale system. The additional photonic layer may provide supplementary optical paths, additional switching capacity, or dedicated channels for specific communication patterns.

The wafer-to-wafer bonded architecture may simplify compiler routing by enabling computer tiles to expose a flat, non-mesh communication abstraction to software. Because any tile can communicate optically with any other tile without being constrained to nearest-neighbor electrical paths, the compiler may treat the array of computer tiles as a fully connected network rather than a mesh topology. This abstraction may simplify the placement and routing of computations, as the compiler does not need to account for the physical distance between communicating tiles or plan data movement through intermediate tiles. Software may address any computer tile directly, and the underlying photonic interconnect may handle the routing transparently.

The optical interconnect architecture may support collective communication primitives that are commonly used in parallel computing workloads. In some embodiments, operations such as all-reduce and all-gather may be performed optically, leveraging the broadcast and multicast capabilities of optical signals. An all-reduce operation, which combines data from all computer tiles and distributes the result back to all tiles, may be implemented using optical fan-in and fan-out structures within the photonic wafer. An all-gather operation, which collects data from all tiles and distributes the complete dataset to all tiles, may similarly benefit from optical multicast capabilities. Performing these collective operations optically may reduce latency and power consumption compared to implementing them through sequential electrical communication.

In some embodiments, the laser bank may include multi-wavelength laser sources that provide redundancy at the bank level rather than at an individual wavelength basis. A multi-color laser source may generate multiple wavelength channels simultaneously, and if one wavelength channel experiences a failure, the switching network may redistribute optical power from other wavelength channels within the same laser bank to compensate. This bank-level redundancy approach may provide more efficient use of backup capacity compared to dedicating individual backup lasers for each wavelength channel.

Semiconductor optical amplifiers (SOAs) may be integrated within the photonic tiles to amplify optical signals. SOAs may be positioned at various locations within the optical signal path depending on the system requirements. In some embodiments, an SOA may be positioned before the transmitter to boost the optical carrier power prior to modulation. In other embodiments, an SOA may be positioned after the transmitter to amplify the modulated signal before transmission to another tile or wafer. In yet other embodiments, an SOA may be positioned before the receiver to amplify incoming optical signals prior to detection. SOAs may be particularly useful for inter-wafer optical communication, where signals must traverse longer optical paths and may experience greater insertion loss.

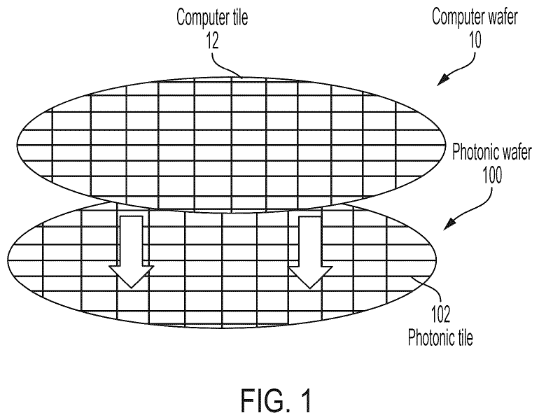

FIG. 1 illustrates an exploded view of a wafer-to-wafer bonding configuration according to some aspects of the present disclosure. A computer wafer 10 may be positioned above a photonic wafer 100. The computer wafer 10 may include a plurality of computer tiles 12 arranged in a grid pattern across the surface of the computer wafer 10. Each computer tile 12 may represent an instantiation of a reticle shot, corresponding to a single lithographic exposure during fabrication. The computer tiles 12 may be electronically stitched together to form a unified large-scale processing system, with electrical interconnects spanning across tile boundaries to enable communication between adjacent tiles. Each computer tile 12 may include one or more computer units such as a central processing unit (CPU), a graphics processing unit (GPU), a tensor processing unit (TPU), an accelerator, or other types of processing elements configured to perform computational operations. In some embodiments, each computer tile 12 may also include local memory, such as high bandwidth memory (HBM) stacked on top of the computer circuitry, to provide high-speed data storage and retrieval for the computer units within the tile. Each computer tile may thus comprise a combination of processing elements and memory elements, with the HBM providing high-speed data storage and retrieval capabilities directly adjacent to the computer logic.

The photonic wafer 100 may similarly include a plurality of photonic tiles 102 arranged in a corresponding grid pattern across the surface of the photonic wafer 100. Each photonic tile 102 may also represent an instantiation of a reticle shot, and the photonic tiles 102 may be photonically stitched together through waveguide routing that extends across tile boundaries to enable optical signal propagation between adjacent tiles.

The computer wafer 10 may be configured to be bonded to the photonic wafer 100 such that the computer tiles 12 align with the photonic tiles 102, enabling communication between the compute and photonic layers. Unlike conventional approaches where individual dies are diced from wafers and then bonded in a die-to-die configuration, the bonding in the present disclosure may be performed at the wafer level without dicing. The entire computer wafer 10 may be bonded to the entire photonic wafer 100, such that all computer tiles 12 and all photonic tiles 102 remain interconnected, forming a unified wafer-scale system. This wafer-level bonding approach may enable substantially larger computers compared to die-to-die bonding, as virtually the full area of the wafer may be utilized for computation and optical communication rather than being limited to the size of individual dies. The wafer-to-wafer bonding may create both mechanical attachment and high-density electrical connections between the compute and photonic layers across the entire wafer surface.

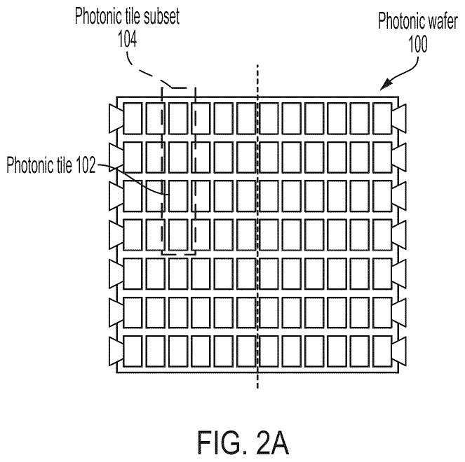

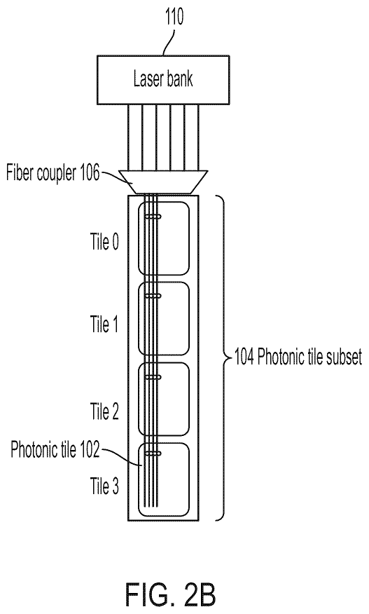

FIG. 2A illustrates a top-down view of a photonic wafer 100 according to some aspects of the present disclosure. The photonic wafer 100 includes an array of photonic tiles 102 arranged in a grid pattern. The photonic tiles 102 are shown as individual rectangular elements arranged in rows and columns across the photonic wafer 100, with each photonic tile 102 being optically coupled to adjacent photonic tiles via internal optical couplers. A photonic tile subset 104 encompasses a group of photonic tiles 102, such as multiple photonic tiles 102 arranged in a vertical column configuration extending from near the top edge of the photonic wafer 100 downward through several rows of the array.

FIG. 2B illustrates a schematic view of a photonic tile subset 104 coupled to a laser bank 110 via a fiber coupler 106 according to some aspects of the present disclosure. The photonic tile subset 104 spans a plurality of photonic tiles 102. The laser bank 110 may be positioned at the top of the arrangement and may provide optical power to the photonic tile subset 104. The fiber coupler 106 may be disposed between the laser bank 110 and the photonic tile subset 104, facilitating the coupling of optical signals from the laser bank 110 into the photonic tiles 102. Multiple optical fibers may extend from the laser bank 110 through the fiber coupler 106 and distribute light to each of the photonic tiles 102 within the photonic tile subset 104. Each photonic tile 102 may include internal waveguide routing that allows optical signals to be directed between adjacent tiles. The fiber coupler 106 may serve as the interface point for external laser sources to supply optical power to the integrated photonic circuitry.

In some embodiments, optical power may be provided to the photonic wafer through external laser delivery, where laser sources are positioned off-chip and coupled to the photonic wafer through edge couplers or grating couplers. Alternatively, lasers may be integrated directly with the photonic wafer, such as by growing laser structures on the bottom side of the photonic integrated circuit after removal of the silicon handle wafer. This integrated laser approach may reduce the number of external optical connections required, though it may introduce additional fabrication complexity.

In some embodiments, the photonic wafer 100 may support wavelength division multiplexing (WDM) to increase the aggregate bandwidth of optical communication channels. WDM may enable multiple optical signals at different wavelengths to propagate simultaneously through a single waveguide, effectively multiplying the data capacity of each physical optical path. Each waveguide may carry 8 or more wavelength channels, 16 or more wavelength channels, 32 or more wavelength channels, or 64 or more wavelength channels, depending on the system configuration and bandwidth requirements. Higher wavelength channel counts may increase the aggregate bandwidth available per waveguide, enabling greater data throughput without requiring additional physical waveguide paths. The laser bank 110 may include multiple laser sources operating at distinct wavelengths, and the photonic tiles 102 may include wavelength-selective components such as arrayed waveguide gratings (AWGs), ring resonator filters, or gratings to multiplex and demultiplex the different wavelength channels. The switching network within the photonic tiles 102 may be configured to route individual wavelength channels independently or to route groups of wavelength channels together, depending on the desired network configuration. WDM may be particularly advantageous in wafer-scale compute architectures where high bandwidth density is required to support the communication demands of multiple computer tiles 12 operating in parallel.

In some embodiments, the communication path between computer tiles 12 may be selected based on the number of tile hops required. When communication is between nearest-neighbor computer tiles 12, corresponding to a single hop (N=1), the communication path may utilize electrical die-to-die interconnects that traverse directly between adjacent tiles without involving the photonic wafer 100. When communication must span two or more tile hops (N≥2), the communication path may utilize optical interconnects provided by the photonic wafer 100. In such cases, a source computer tile 12 may transmit data to its corresponding photonic tile 102, which may then route the optical signal through the switching network within the photonic wafer 100 to reach a destination photonic tile 102 aligned with the target computer tile 12. This hybrid approach may leverage the strengths of each interconnect technology, using electrical interconnects for short-distance communication where they are efficient and optical interconnects for longer-distance communication where they avoid the cumulative parasitic effects of traversing multiple intermediate tiles electrically.

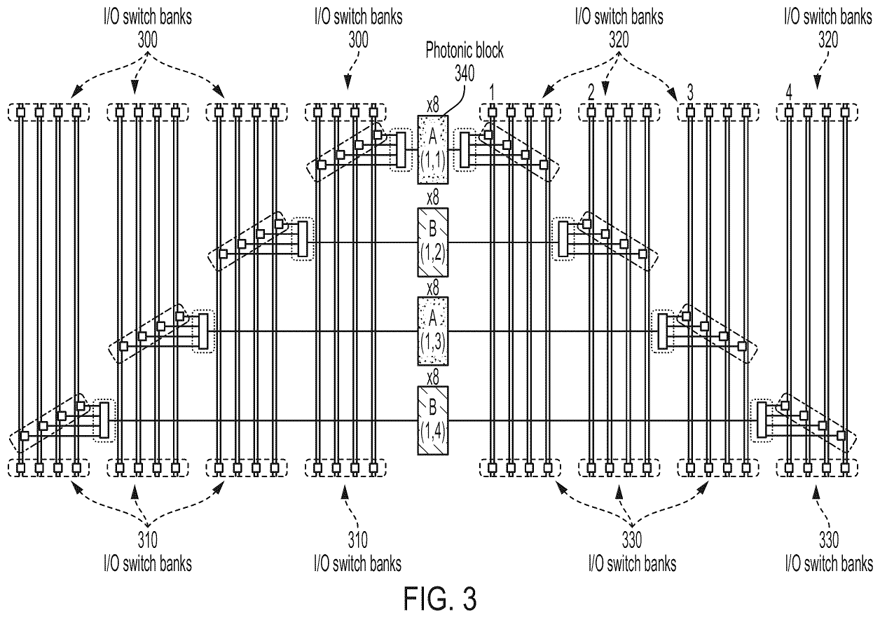

FIG. 3 illustrates a potential implementation of a photonic tile according to some aspects of the present disclosure. The photonic tile may be an edge tile or a central tile. An edge tile may be a photonic tile positioned along the perimeter of the photonic wafer 100, adjacent to the wafer boundary. A central tile may be a non-edge tile positioned in the interior of the photonic wafer 100, surrounded by other photonic tiles on all sides.

A photonic tile may include I/O switch banks 300 positioned along a first edge. I/O switch banks 310 may be positioned along a second edge opposite to the first edge. I/O switch banks 320 may be positioned along the first edge adjacent to I/O switch banks 300. I/O switch banks 330 may be positioned along the second edge adjacent to I/O switch banks 310. The I/O switch banks 300, 310, 320, and 330 may each include multiple individual switch units arranged in rows.

The I/O switches may be programmed on the basis of whether the tile is an edge tile or a central tile. Edge tiles may be positioned along the perimeter of the photonic wafer 100 and may interface directly with external components such as laser sources and fiber connections. Central tiles may be positioned in the interior of the photonic wafer 100 and may be surrounded by other photonic tiles on all sides. The programming of the I/O switches may determine whether the switches are configured to couple optical signals to external interfaces or to adjacent photonic tiles. For edge tiles, the I/O switches may be programmed to receive optical power from external laser sources through edge couplers and to transmit modulated optical signals to external fiber connections. For central tiles, the I/O switches may be programmed to receive optical signals from neighboring photonic tiles and to route modulated optical signals to adjacent tiles for propagation toward the edge of the wafer or to other destination tiles within the wafer.

In some aspects, any photonic tile may be configured to function as an I/O tile, regardless of its position on the photonic wafer. At least one photonic tile positioned in an interior of the photonic wafer, rather than along a perimeter, may be configured to exchange optical signals with an external optical source or sink. This configuration may allow data to enter or exit the wafer-scale system without first traversing a perimeter tile. Interior I/O capability may be achieved using grating couplers that couple light vertically into or out of the photonic tile, in addition to edge fiber coupling used at perimeter tiles. Grating couplers may enable optical access to interior tiles by directing light perpendicular to the wafer surface, allowing external fibers or other optical components to interface with tiles that are not located at the wafer edge. This flexibility in I/O placement may reduce routing congestion at the wafer perimeter and enable more efficient data distribution across the wafer-scale system.

A photonic block 340 may be positioned centrally within a tile. The photonic block 340 may connect to the surrounding I/O switch banks. In some embodiments, the photonic block 340 may include connections that interface with the computer wafer through the hybrid bonding connections. The photonic block 340 may include a bank of transceivers. Each transceiver may include a transmitter with modulators that encode light with data. The data may be provided by the corresponding computer tile on the computer wafer. The modulators within the transmitters may include Mach-Zehnder modulators, ring modulators, or electro-absorption modulators configured to impart data onto the optical carrier signals received from the laser sources. The modulators may operate at data rates compatible with serializers/deserializers (SerDes) lanes, such as 112 Gbps per lane, enabling aggregate bandwidths of multiple terabits per second per photonic tile. In some embodiments, the modulators may support four-level pulse amplitude modulation (PAM-4) to achieve these data rates. For example, a photonic tile with 64 lanes operating at 112 Gbps may provide an aggregate bandwidth of approximately 7.168 Tbps.

The photonic communication links may support various modulation formats and protocols. In some embodiments, the transceivers may employ intensity modulation with direct detection (IM/DD), which may include non-return-to-zero (NRZ) modulation, four-level pulse amplitude modulation (PAM-4), or other amplitude-based modulation schemes. In other embodiments, the transceivers may employ coherent modulation, which may enable higher spectral efficiency by encoding data in both the amplitude and phase of the optical signal. Coherent-lite approaches, which may use simplified coherent detection without full digital signal processing, may also be employed. Quadrature amplitude modulation (QAM) formats may be used in coherent or coherent-lite configurations to further increase data capacity per wavelength channel.

Each transceiver may also include a receiver with photodetectors that convey data extracted from optically modulated signals to the corresponding computer tile. The receivers within the transceivers may include germanium photodetectors or other photodetector structures capable of converting modulated optical signals back into electrical signals. The photodetectors may be coupled to transimpedance amplifiers that condition the received signals for processing by the computer tile. Monitor photodiodes may be integrated within the photonic block 340 to detect optical power levels and identify failures in the optical signal chain. When a monitor photodiode detects a loss of light or reduced optical power in a particular lane, the monitor photodiode may generate a telemetry signal that triggers reconfiguration of the I/O switches to reroute optical signals through alternative paths.

The photonic block 340 may support both unidirectional and bidirectional communication configurations. In a unidirectional configuration, separate waveguide paths may be dedicated to transmit and receive functions. In a bidirectional configuration, a single waveguide path may carry both transmit and receive signals, potentially using different wavelengths or time-division multiplexing to separate the two directions of communication. The photonic block 340 may also support interleaved or multiplexed arrangements where multiple data streams share common optical infrastructure through wavelength division multiplexing or other multiplexing techniques.

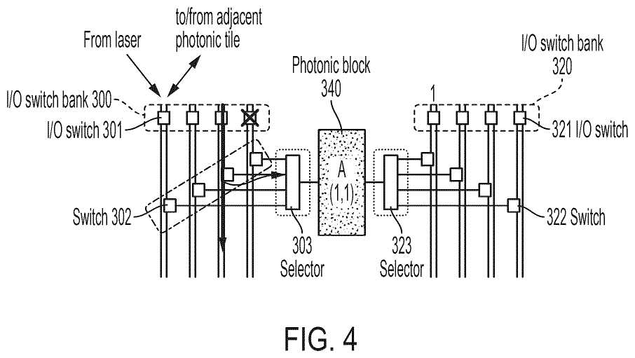

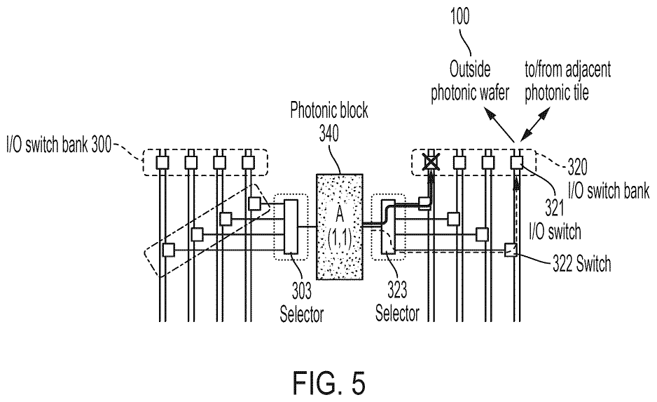

Waveguides illustrated as extending in the vertical direction of FIG. 3 couple the I/O switch banks at the top and bottom edges together. These waveguide paths may provide optical routing channels through the photonic tiles. As described below, the diagonal switch components within the I/O switch banks may provide routing flexibility. This configuration may enable redundancy and reconfiguration capabilities. If one optical path experiences a failure, the switches may redirect optical signals through alternative paths. FIGS. 4 and 5 provide more detailed views of the switching and routing architecture within a photonic tile, illustrating how the I/O switch banks, switches, selectors, and photonic block work together to enable the redundancy and reconfiguration capabilities described above.

FIG. 4 illustrates a detailed block diagram of a photonic tile configuration showing the routing and switching architecture for laser input and data output according to some aspects of the present disclosure. Within the I/O switch bank 300, individual units may include I/O switches 301. An I/O switch 301 may interface with external laser sources or with adjacent photonic tiles, determining whether optical signals are received from off-chip or from a neighboring tile.

The switch 302 may couple individual waveguides at the output of the I/O switches 301 to the selector 303. The switch 302 may be controllable to route light downward along the vertical waveguide path and/or laterally toward the selector 303 when a particular lane is designated to provide backup for a defective laser source or edge coupler. In some embodiments, the switch 302 may divide optical power between the downward path and the lateral path, enabling a single laser source to serve both its primary lane and provide partial redundancy to an adjacent lane experiencing a failure. This power division capability may allow the system to maintain functionality in multiple lanes even when one laser source has failed, without requiring complete duplication of all laser sources. The selector 303 may function to select one input from multiple available inputs to route toward the photonic block 340, passing through only the selected input while blocking the others.

As illustrated in FIG. 4, a defective laser source or failed edge coupler may be indicated by the X mark on one of the input paths. In this scenario, optical power that would normally be provided through the failed path is unavailable. The switching architecture may respond by diverting light from the defective lane to a backup lane. The switch 302 associated with an adjacent functional laser source may be reconfigured to direct a portion of its optical power laterally toward the selector 303. The selector 303 may then be configured to accept this rerouted optical power and direct it toward the photonic block 340, thereby restoring functionality to the affected lane. The paths highlighted in FIG. 4 illustrate this alternative routing, demonstrating how the redundancy mechanism enables continued operation despite the presence of a defective component.

FIG. 5 illustrates a detailed view of the switching and routing architecture within a photonic tile of the photonic wafer 100 according to some aspects of the present disclosure. Within the I/O switch bank 320, individual units may include I/O switches 321. An I/O switch 321 may interface with external destinations or with adjacent photonic tiles, determining whether modulated optical signals are directed off-chip or to a neighboring tile. The switch 322 may couple individual waveguides at the output of the photonic block 340 to the selector 323. The switch 322 may be controllable to route modulated optical signals incoming from the bottom side of the tile or from the selector 323 when a particular output lane is designated to provide an alternative path for a defective edge coupler. In some embodiments, the switch 322 may divide optical power between the upward path and the lateral path, enabling a single output signal to be directed to multiple destinations. The selector 323 may function to select one output from multiple available outputs to route toward the I/O switch 321, passing through only the selected output while blocking the others.

As illustrated in FIG. 5, a defective edge coupler may be indicated by the X mark on one of the output paths. In this scenario, the modulated optical signal that would normally exit through the failed path is unable to reach its intended destination. The switching architecture may respond by diverting light from the defective optical lane to a backup optical lane. The switch 322 may be reconfigured to redirect the modulated optical signal laterally toward an alternative output path. The selector 323 may then be configured to accept this rerouted signal and direct it toward a functional I/O switch 321. The I/O switch bank 320 may provide connectivity both to the outside of the photonic wafer 100 and to adjacent photonic tiles, as indicated by the routing options shown in FIG. 5. This architecture may enable dynamic reconfiguration of optical signal paths for redundancy and network topology flexibility, allowing signals to be routed either externally to a different wafer or to neighboring tiles within the same wafer as needed.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

As used herein, terms such as “above,” “below,” “over,” “under,” “adjacent,” “upper,” “top,” “lower,” “bottom,” “vertical,” “horizontal,” “lateral,” and similar positional or directional descriptors are used solely to describe the relative arrangement and orientation of features as illustrated in the drawings and are not intended to be limiting. Such terms do not require any particular orientation of the device in use, manufacture, or operation, and the described features may be oriented in any direction without departing from the scope of the present disclosure. Moreover, these terms are not intended to imply any absolute position, gravitational reference, or fixed spatial relationship, and components described as being positioned using positional or directional descriptors may be arranged in different relative positions, including inverted, rotated, or otherwise reoriented configurations, while still performing the same function in substantially the same way to achieve substantially the same result.

What is claimed is:

1. A system comprising:
a photonic wafer patterned with a plurality of photonic tiles;
a computer wafer patterned with a plurality of computer tiles, wherein the computer wafer is bonded to the photonic wafer such that each photonic tile of the plurality of photonic tiles is coupled to a corresponding computer tile of the plurality of computer tiles;
wherein each photonic tile comprises:
a plurality of optical lanes configured to carry optical signals;
a plurality of monitoring photodetectors configured to detect optical power levels in the plurality of optical lanes; and
a plurality of switches coupled to the plurality of optical lanes;
wherein each photonic tile is configured to:
detect a defect on an optical lane of the plurality of optical lanes based on a reduced optical power level detected by a monitoring photodetector of the plurality of monitoring photodetectors; and
in response to detecting the defect, control the plurality of switches to divert light from the defective optical lane to a backup optical lane.

2. The system of claim 1, wherein each photonic tile further comprises a photonic block comprising a plurality of transceivers configured to transmit data to and receive data from the corresponding computer tile.

3. The system of claim 2, wherein each transceiver comprises a transmitter including a modulator configured to encode data onto an optical carrier signal and to support four-level pulse amplitude modulation (PAM-4), the modulator comprising a Mach-Zehnder modulator, a ring modulator, or an electro-absorption modulator.

4. The system of claim 2, wherein each photonic tile further comprises a selector coupled to the plurality of switches, the selector configured to select one input from a plurality of available inputs provided by the plurality of switches and to route the selected input toward the photonic block.

5. The system of claim 4, wherein the plurality of switches are configured to route light to the selector in response to detecting the defect and to route light to a neighboring photonic tile when no defect is detected.

6. The system of claim 5, wherein, in response to detecting the defect, the plurality of switches are configured to divide optical power such that a first portion of the optical power is routed to the selector and a second portion of the optical power is routed to the neighboring photonic tile.

7. The system of claim 1, wherein each photonic tile further comprises a plurality of I/O switches, each I/O switch configured to interface with an external source or with an adjacent photonic tile.

8. The system of claim 7, wherein the plurality of I/O switches are programmed based on whether the photonic tile is an edge tile positioned along a perimeter of the photonic wafer or a central tile positioned in an interior of the photonic wafer.

9. The system of claim 1, wherein the defect comprises a defective laser source or a defective edge coupler.

10. The system of claim 1, wherein at least one photonic tile positioned in an interior of the photonic wafer is configured to exchange optical signals with an external optical source or sink via a grating coupler, such that data enters or exits the system without first traversing a perimeter photonic tile.

11. A system comprising:
a first photonic wafer patterned with a plurality of photonic tiles;
a first computer wafer patterned with a plurality of computer tiles, wherein the first computer wafer is bonded to the first photonic wafer such that each photonic tile of the plurality of photonic tiles is coupled to a corresponding computer tile of the plurality of computer tiles;
wherein communication between nearest-neighbor computer tiles is conducted via electrical die-to-die interconnects; and
wherein communication between non-nearest-neighbor computer tiles is conducted via the first photonic wafer.

12. The system of claim 11, further comprising a second photonic wafer bonded to a second computer wafer, wherein the first photonic wafer is optically coupled to the second photonic wafer such that a computer tile on the first computer wafer communicates optically with a computer tile on the second computer wafer without electrical tile-to-tile hops.

13. The system of claim 11, wherein each photonic tile comprises a plurality of optical lanes and a plurality of switches coupled to the plurality of optical lanes, the plurality of switches configured to route optical signals between photonic tiles.

14. The system of claim 11, wherein the first photonic wafer and the first computer wafer are bonded through wafer-on-wafer hybrid bonding.

15. The system of claim 11, wherein the first photonic wafer is optically coupled to an external optical switch such that a computer tile on the computer wafer communicates optically with the external optical switch without electrical tile-to-tile hops.

16. A photonic wafer comprising:
a plurality of photonic tiles arranged in a grid pattern, each photonic tile comprising:
a plurality of optical lanes configured to carry optical signals;
a plurality of monitoring photodetectors configured to detect optical power levels in the plurality of optical lanes; and
a plurality of switches coupled to the plurality of optical lanes;
wherein each photonic tile is configured to:
detect a defect on an optical lane of the plurality of optical lanes based on a reduced optical power level detected by a monitoring photodetector of the plurality of monitoring photodetectors; and
in response to detecting the defect, control the plurality of switches to divert light from the defective optical lane to a backup optical lane;
wherein the photonic wafer is configured for wafer-to-wafer bonding with a computer wafer such that each photonic tile is aligned with a corresponding computer tile of the computer wafer.

17. The photonic wafer of claim 16, wherein each photonic tile further comprises a photonic block comprising a plurality of transceivers configured to interface with a corresponding computer tile when the photonic wafer is bonded to the computer wafer.

18. The photonic wafer of claim 16, wherein the photonic wafer and the computer wafer are bonded through wafer-on-wafer hybrid bonding.

19. The photonic wafer of claim 16, wherein the defect comprises a defective laser source or a defective edge coupler.

20. The photonic wafer of claim 16, wherein at least one photonic tile positioned in an interior of the photonic wafer is configured to exchange optical signals with an external optical source or sink via a grating coupler, such that data enters or exits the photonic wafer without first traversing a perimeter photonic tile.
